(19) United States
(12) Patent Application Publication
(10) Pub. No.: US 2016/0255537 A1
(43) Pub. Date: Sep. 1, 2016

(54) MOBILE COMMUNICATION SYSTEM AND MOBILE DEVICE

(71) Applicant: NTT DOCOMO, INC., Tokyo (JP)

(72) Inventors: Tooru Uchino, Tokyo (JP); Hideaki Takahashi, Tokyo (JP)

(73) Assignee: NTT DOCOMO, INC., Tokyo (JP)

(21) Appl. No.: 15/027,300

(22) PCT Filed: Jan. 16, 2015
(86) PCT No.: PCT/JP2015/051043

§ 371 Date: Apr. 5, 2016

(30) Foreign Application Priority Data
Jan. 30, 2014 (JP) 2014-015086

(51) Int. Cl. H04W 28/02; H04W 72/04; H04W 76/02

(52) U.S. Cl. CPC H04W 28/0278; H04W 76/025; H04W 72/0413; H04W 88/06

(57) ABSTRACT

A mobile communication system includes a first base station, a second base station, and a mobile device, wherein when uplink bearer splitting is arranged between the first base station, second base station, and the mobile device at a prescribed splitting ratio, and when the amount of data accumulated in a buffer of the mobile device does not exceed a threshold level, the mobile device transmits a buffer status report to either the first base station or the second base station even if the uplink bearer splitting is arranged, and when the amount of data accumulated in the buffer exceeds the threshold level, the mobile device divides the amount of data accumulated in the buffer at the splitting ratio and transmits the buffer status reports to the first base station and the second base station according to the divided amounts of data accumulation.

### TECHNICAL FIELD

The present invention relates to the field of mobile telecommunications, and more particularly, to resource allocation control for uplink bearer splitting.

### BACKGROUND ART

Third Generation Partnership Project (3GPP) standardization provides carrier aggregation (CA) to perform telecommunications bundling multiple component carriers (CCs).

Up to Long Term Evolution (LTE) Release 10 carrier aggregation, multiple component carriers supported by a single radio base station or evolved NodeB (abbreviated as “eNB”) are aggregated and transmitted simultaneously to increase the throughput.

The 3GPP LTE-Release 12 expands intra-eNB carrier aggregation and discusses “dual connectivity” that can transmit multiple component carriers utilized by different eNBs simultaneously. See, for example, 3GPP TS36.842 as well as 3GPP TSG-RAN WG2 Meeting #82, Fukuoka, Japan 20-24 May 2013, R2-131782. Dual connectivity may be referred to as inter-eNB carrier aggregation and further improvement of throughput is expected.

For example, to achieve the throughput as high as that of Release 10 under the situation where necessary component carriers cannot be aggregated in a single eNB, dual connectivity is an effective architecture.

In dual connectivity, “bearer splitting” function is discussed, which function aims to increase throughput by using resources of multiple eNBs to configure an evolved packet system (EPS) bearer.

FIG. 1 schematically illustrates uplink (UL) bearer splitting. Data generated at a mobile device (which may be referred to as a user equipment device abbreviated as “UE”) 10 are transmitted using a component carrier (CC#1) of the first eNB 20-1 and a component carrier (CC#2) of the second eNB 20-2 simultaneously, as indicated by the arrows (1). During the transmission, data packets are divided between CC#1 and CC#2 at a certain ratio. See, for example, 3GPP TSG-RAN WG2 Meeting #84, San Francisco, USA, 11-15 Nov. 2013, R2-134427. The second eNB 20-2 transfers the data packets received from the UE to the first eNB 20-1 that serves as an anchor node, as indicated by the arrow (2). The first eNB 20-1 reorders the data packets received from the UE and the data packets transferred from the second eNB 20-2. The reordered data are transmitted to a core network (CN), as indicated by the arrow (3).

### SUMMARY OF THE INVENTION

### Technical Problem to be Solved

During implementation of UL bearer splitting, data packets are split at a certain ratio and the divided portions of the data packets are transmitted to the first eBN and the second eNB, respectively. In this case, the amount of data accumulated in the UE's buffer is also divided at that ratio and buffer status reports (BSRs) are created and reported for the respective data accumulations at the splitting ratio. For example, when UL bearer splitting is implemented between the first eNB and the second eNB at a ratio of one to two (1:2), the amount of data accumulated in the UE's buffer is also divided at the 1:2 ratio and BSR is created and reported for each of the divided accumulations. As a result, the UL resource allocation ratio between CC#1 allocated to the UE 10 from the first eNB and CC#2 allocated to the UE 10 from the second eNB becomes 1 to 2.

In the existing technique, the amount of buffered data is always divided and BSRs are reported based upon the divided amount of data accumulation during implementation of UL bearer splitting, even though the UL data size in the UE 10 is small. Such arrangement is undesired from the viewpoints of efficient use of resources and prevention of delay in uplink transmission. When the amount of data is small, it may be better to transmit a BSR to either one of eNBs at once and receive resource allocation from that eNB.

Therefore, it is an objective of the invention to provide a technique t can achieve efficient uplink resource allocation for a mobile device (or UE) when implementing UL bearer splitting.

### Means for Solving the Problem

To achieve the objective, in one aspect of the invention, a mobile communication system includes a first base station, a second base station, and a mobile device,

wherein when uplink bearer splitting is arranged between the first base station, second base station, and the mobile device at a prescribed splitting ratio, and when the amount of data accumulated in a buffer of the mobile device does not exceed a threshold level, the mobile device is configured to transmit a buffer status report to either one of the first base station or the second base station even if the uplink bearer splitting is arranged, and

wherein when the amount of data accumulated in the buffer of the mobile device exceeds the threshold level, the mobile device is configured to divide the amount of data accumulated in the buffer at the prescribed splitting ratio, and transmit buffer status reports to the first base station and the second base station according to the divided amounts of data accumulation.

In another aspect of the invention, a mobile device includes

a splitting ratio manager configured to manage a splitting ratio for uplink bearer splitting arranged between two or more base stations,

an uplink data manager configured to manage an amount of data accumulated in a buffer, and

a determination unit configured to determine if the amount of data accumulated in the buffer exceeds a threshold level upon triggering a buffer status report,

wherein when the amount of data accumulated in the buffer does not exceed the threshold, the uplink data manager is configured to perform first type buffer status reporting to transmit a buffer status report to a part of the base stations even if the uplink bearer splitting is arranged, and

when the amount of data accumulated in the buffer exceeds the threshold level, the uplink data manager is configured to perform second type buffer status reporting by dividing the amount of data accumulated in the buffer at the splitting ratio and reporting buffer status reports created based upon the splitting ratio to said two or more base stations.

### Advantageous Effect of the Invention

In implementing UL bearer splitting, efficient uplink resource allocation for a mobile device can be achieved.

### BRIEF DESCRIPTION OF THE DRAWINGS

FIG. 1 is a diagram to explain uplink bearer splitting;

FIG. 2 is a flowchart of resource allocation according to the embodiment of the invention;

FIG. 3 illustrates an example of BSR control taking into account the amount of data accumulated in the buffer;

FIG. 4 illustrates an example of BSR control taking into account the amount of data accumulated in the buffer; and

FIG. 5 is a schematic block diagram of a mobile device according to the embodiment.

### EMBODIMENTS TO CARRY OUT THE INVENTION

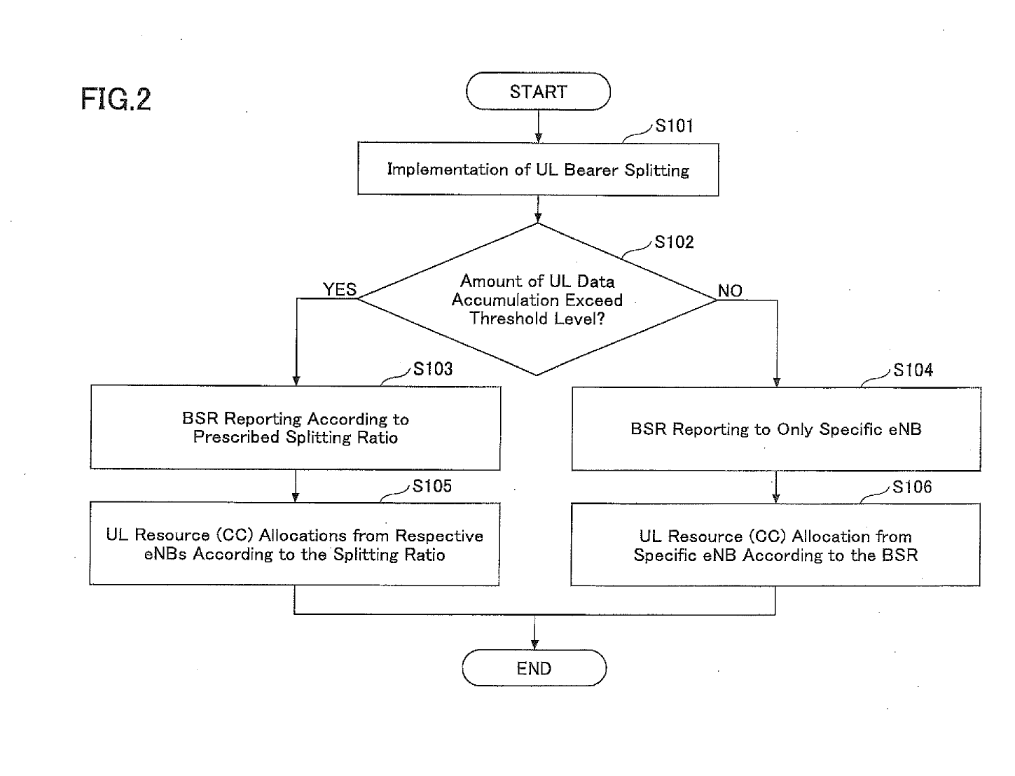

FIG. 2 is a flowchart of resource allocation control according to the embodiment. In the embodiment, when the UL data size accumulated in UE does not exceed a threshold level during implementation of UL bearer splitting, a BSR is transmitted to a specific eNB even if UL bearer splitting is arranged. By transmitting the BSR to only the specific eNB, this specific eNB solely carries out allocation of a UL resource (or component carrier) for UL data transmission. Consequently, the efficiency of UL resource allocation can be improved.

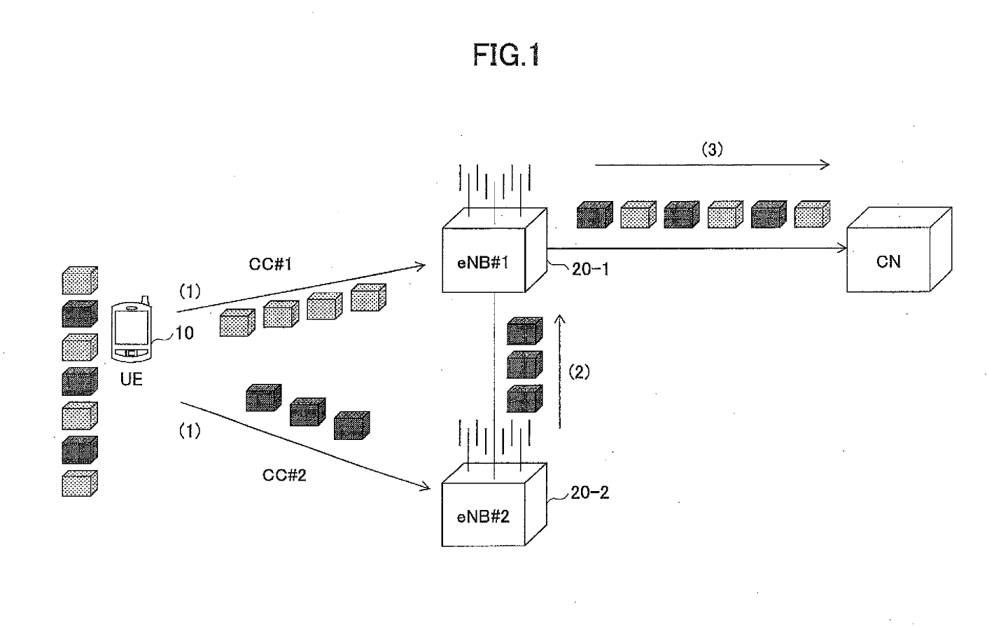

First, UL bearer splitting is implemented under the situation where the UE 10 (see FIG. 1) is connected to the first base station (S101). Implementation of UL bearer splitting includes setting (or configuring) and alteration of UL bearer splitting. In particular, setting and/or changing dual connectivity, setting and/or changing cells or component carriers supported by the second base station to be involved in dual connectivity, and setting and/or changing the splitting ratio between base stations or eNBs are included. Setting and alteration of UL bearer splitting are determined based upon, for example, the amount of data accumulated in the buffer of the first base station, the received power level between the UE 10 and the second base station, or other factors. Splitting ratios may be provided for respective combinations of eNBs for which UL bearer splitting is arranged at that point of time.

In the implementation of UL bearer splitting, a request for setting (configuring) or changing UL bearer splitting is sent to the UE 11 from, for example, the first base station to which the UE 10 has established radio connection. The request for setting/changing UL bearer splitting is sent to the UE 10 using, for example, a radio resource control (RRC) signaling message. The first base station may be called a master eNB (MeNB). For instance, a macro base station may serve as the MeNB. The second base station to be involved in UL bearer splitting may be called a secondary eNB (SeNB). For instance, a small base station such as a pico eNB may serve as the SeNB. Responsive to the request for setting/changing UL bearer splitting, the UE 10 allocates UL bearer splitting between MeNB and SeNB.

Under the situation where UL bearer splitting has been set up, upon triggering a BSR, the UE 10 determines whether the amount of data accumulated in its buffer exceeds a threshold level (S102). The threshold level may be designated from the MeNB by means of RRC signaling. Since UL bearer splitting is implemented typically when a large amount of UL data is generated and accumulated in the UE 10, the determination of S102 becomes affirmative in general (YES in S102). In this case, the UE 10 divides the amount of buffered data according to the currently designated splitting ratio and transmits the BSRs for the divided portions of data accumulation to the MeNB and the SeNB, respectively (S103).

The BSR transmission may be carried out according to the ordinary BSR procedures standardized in LTE systems. If the UE 10 has a dedicated UL resource (such as a PUCCH-scheduling request) of the SeNB, the UE 10 transmits a scheduling request to the SeNB and then transmits the BSR to the SeNB over a physical uplink shared channel (PUSCH) corresponding to the allocated UL grant.

If the UE 10 does not have a dedicated UL resource of the SeNB, the UE 10 starts random access procedures and transmits the BSR over a PUSCH corresponding to the UL grant designated in a random access (RA) response. The total amount of data is calculated for each logical channel (LCH) group in which data exist and the total amount of data is divided at the splitting ratio for creation of BSRs.

Following the BSR reporting, component carriers are allocated to the UE 10 from the MeNB and the SeNB. The UE 10 transmits UL data using the allocated component carriers to the MeNB and the SeNB simultaneously (S105).

On the other hand, when the amount of UL data accumulated in the UE 10 does not exceed the threshold level (NO in S102), the UE 10 transmits a BSR to only a specific eNB (S104). The specific eNB may be designated by the network, or MeNB may become the specific eNB. An eNB with the largest or the smallest index number among the eNBs involved in dual connectivity may be selected as the specific eNB. Alternatively, an eNB with the highest average UL transmission rate, an eNB that carried out resource allocation the last time, an eNB with a time alignment (TA) timer activated (configured with a dedicated resource), or other appropriate eNB may be selected.

The case in which UL bearer splitting is implemented and the amount of UL data accumulation does not exceed the threshold level is, for example, immediately after the UL data have been transmitted from the UE 10 under the operations of UL bearer splitting. Since UE 10 is likely to continuously generate UL data during implementation of UL bearer splitting, the UL bearer splitting may be maintained for a certain period of time even after the UL data have been transmitted. In this case, it is preferable for the UE 10, because of the small amount of UL data accumulation, to transmit a BSR to a single eNB (e.g., MeNB) even if UL bearer splitting is implemented. Accordingly, UE 10 transmits a BSR to only the specific base station (S104). After the transmission of the BSR, component carrier(s) is/are allocated to the UE 10 from the specific base station in accordance with the BSR value (S106).

Even if the amount of UL data accumulation in UE 10 has once exceeded the threshold level, the amount of data pending in the UE 10 becomes at or below the threshold level upon transmission of the accumulated UL data. In this case, again BSR reporting is made to only the specific eNB.

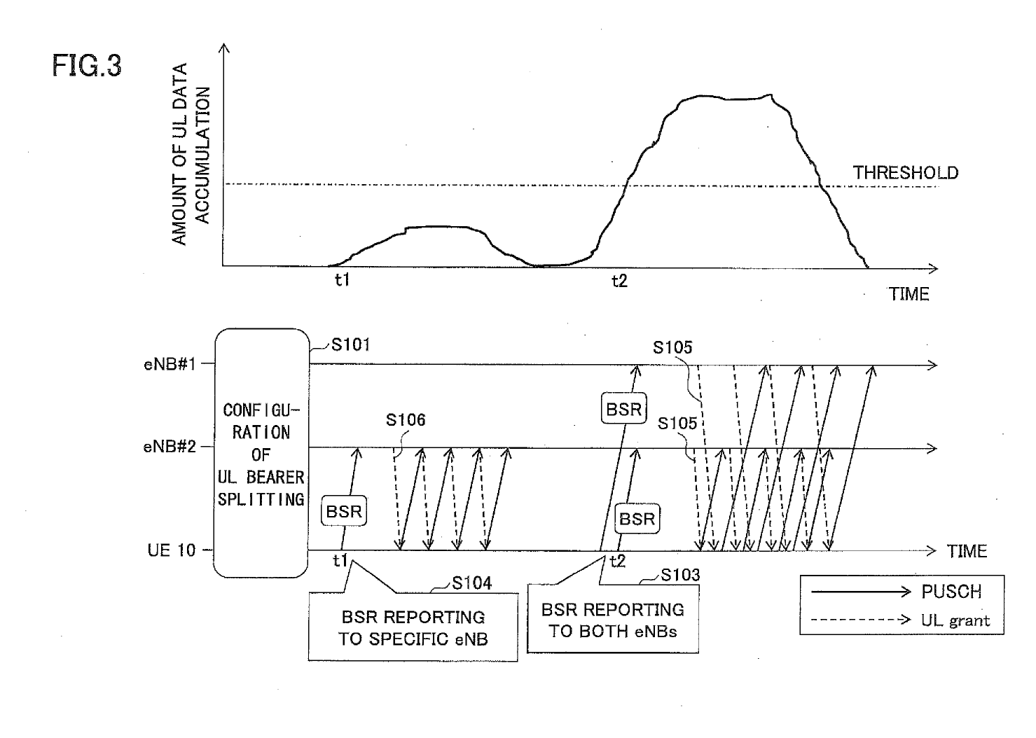

FIG. 3 illustrates an example of resource allocation control performed during UL bearer splitting according to the embodiment. In this example, UL bearer splitting is carried out between UE 10 and two base stations eNB#1 and eNB#2 (Sl01).

At time t1, a BSR is triggered in the UE 10. BSR triggering occurs, for example, when there is no data left to be transmitted, when a periodic BSR timer has expired (periodic BSR triggering), when data with higher priority have been generated, when the number of surplus bits of medium access control protocol data unit (MAC PDU) is greater than the number of bits required for storing the BSR (padding BSR), etc. The state illustrated in FIG. 3 is one immediately after the UL data accumulated in the UE 10 has been transmitted using the component carrier of eNB#1 and the component carrier of eNB#2 under the operations of UL bearer splitting.

At time t1, the UL data accumulated in the UE 10 is less than the threshold (NO in S102 of FIG. 2). Accordingly, the UE 10 transmits a BSR to only a specific eNB, that is, eNB#2 in this example (S104). The UE 10 receives UL grant allocations from eNB#2 in accordance with the BSR value (S106). Then the UE transmits the accumulated UL data to eNB#2 using the component carrier designated by the UL grant.

Then, at time t2, a new BSR is triggered. The amount of UL data buffered in the UE 10 exceeds the threshold level (YES in S102 of FIG. 2). The UE divides the amount of the buffered UL data according to the splitting ratio set up in the UE 10 and transmits BSRs to the eNB#1 and the eNB#2, respectively (S103). UE 10 receives UL grant allocations from the eNB#1 and the eNB#2 according to the BSR values (S105), and transmits the buffered UL data to the eNB#1 and the eNB#2, respectively, using the component carriers designated by the respective UL grants.

Because the amount of data accumulated in the buffer of UE 10 may vary dynamically, protection steps (time based hysteresis) may be provided for comparison with the threshold level, or hysteresis may be provided to the threshold level. Different values of hysteresis calculation of the threshold level may be provided depending on the switching directions of BSR reporting. Threshold hysteresis used when BSR reporting to a specific one (e.g., eNB#1) is switched to BSR reporting to two or more eNBs such as eNB#1 and eNB#2 (switching case (i)) and threshold hysteresis used when BSR reporting to eNB#1 and eNB#2 is switched to BSR reporting to only a specific eNB (switching case (ii)) may be different. The number of protection steps or hysteresis for threshold level may be designated by the network. For example, for a UE in which a large amount of UL data is likely to be generated, the hysteresis for the switching case (i) may be reduced (or a negative value may be set for the hysteresis) such that BSRs are reported promptly to both eNB#1 and eNB#2 upon generation of UL data. Alternatively, hysteresis may be provided as a parameter inside the UE 10.

Once UL data are generated exceeding the threshold level, it is expected that UL data are continuously generated. Accordingly, once BSRs are transmitted to both eNB#1 and eNB#2, this type of BSR reporting (transmitting BSRs to two or more eNBs) may be maintained for a certain period of time regardless of the amount of UL data accumulation.

It is assumed that in general, transmission control protocol (TCP) communication with high reliability is conducted. In TCP communication, an ACK message is transmitted to a sender for data received from the sender. In response to the ACK message, the sender transmits subsequent data items. When a large amount of DL data is received on the receiver side, it is expected that ACK messages corresponding to the received amount of UL data are generated. Accordingly, the amount of DL messages received at the UE for a prescribed period of time a may be used, in place of or together with the amount of UL data accumulation, as an index to determine whether to transmit BSRs to both eNB#1 and eNB#2.

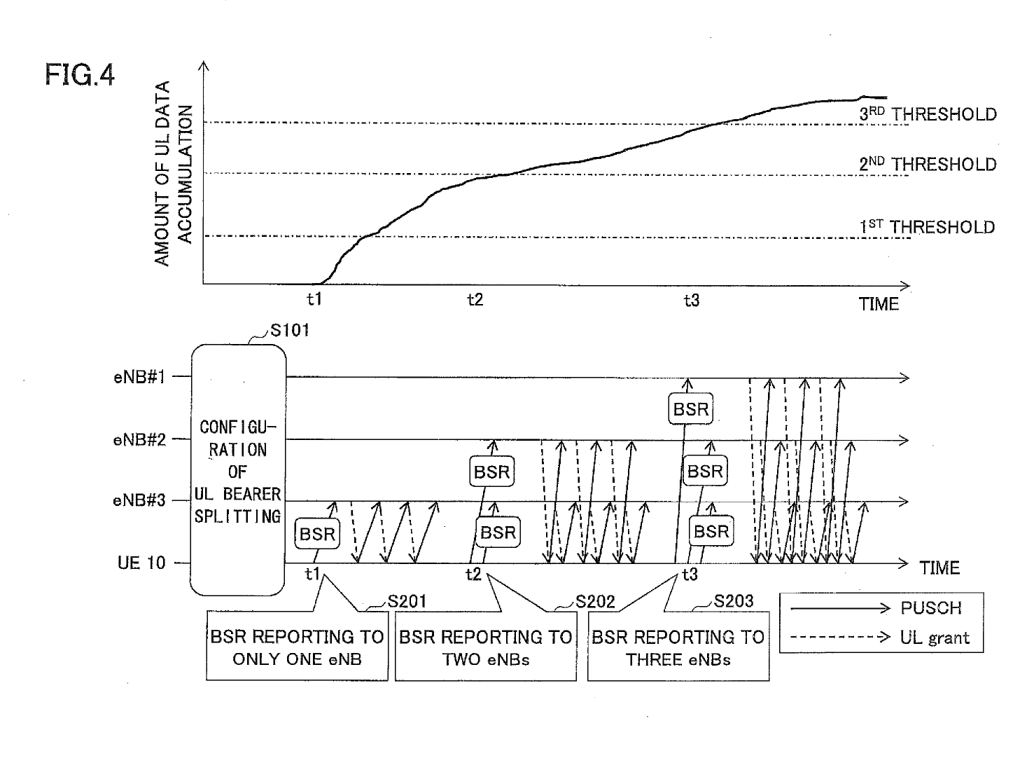

FIG. 4 illustrates a modification of FIG. 3. In FIG. 4, three or more eNBs are involved in dual connectivity. In this case, the number of eNBs to which BSRs are transmitted may be variable depending on the amount of data accumulated in UE 10. To which eNBs the BSRs are transmitted under dual connectivity may be determined in advance, for example, in descending order of average data rate or descending or ascending order of index number of eNB. Depending on the number of eNBs that receive BSRs, the splitting ratio may be determined in advance. Alternatively, the amount of data accumulation in buffer may be equally divided by the number of eNBs to which BSRs are transmitted. The eNB counted as one involved in dual connectivity is, for example, an eNB for which at least one component carrier is n “Active”, an eNB that has at least one timing advance group (TAG) with time alignment timer activated, an eNB that has at least one component carrier with quality at or above a threshold, and so on. The quality of component carriers includes but is not limited to channel quality indicator (CQI), rank indicator (RI), precoding type indicator (PTI), precoding matrix indicator (PMI), reference signal received power (RSRP), and reference signal received quality (RSRQ).

In FIG. 4, three different threshold levels are set for the amount of data accumulated in the buffer of UE 10. Under the situation where UL bearer splitting is implemented (S101), a BSR is triggered at time t1, and the UE 10 compares the amount of data accumulation in buffer with the threshold levels. If the amount of data accumulation in buffer is greater than the first threshold level and less than or equal to the second threshold level, the UE 10 transmits a BSR to a specific eNB, for example, eNB#3 (S201). Then, the UE 10 receives a UL grant from eNB#3 and transmits UL data over the designated component carrier.

If the amount of data accumulation in buffer is greater than the second threshold level and less than or equal to the third threshold level, the UE transmits BSRs to two eNBs, for example, eNB#2 and eNB#3. The BSRs transmitted to the two eNBs indicate the amounts of divided portions of the data accumulation, in accordance with the currently set splitting ratio. As a result, the UE 10 receives UL grants from eNB#2 and eNB#3, respectively, according to the BSR values (S202). The UE 10 transmits the UL data using a component carrier supported by eNB#2 and a component carrier supported by eNB#3.

If the amount of data accumulation in buffer is greater than the third threshold level, the UE transmits BSRs to three eNBs, eNB#1, eNB#2 and eNB#3 in this example and receives UL grants from the eNB#1 to eNB#3, respectively (S203). The UE transmits the UL data using the component carriers supported by the respective eNBs.

The architecture of FIG. 4 can achieve more efficient use of uplink component carriers by varying the number of base stations (eNBs) that implement dual connectivity depending on the amount of data accumulation in the buffer of the UE 10 under the situation where UL bearer splitting is arranged.

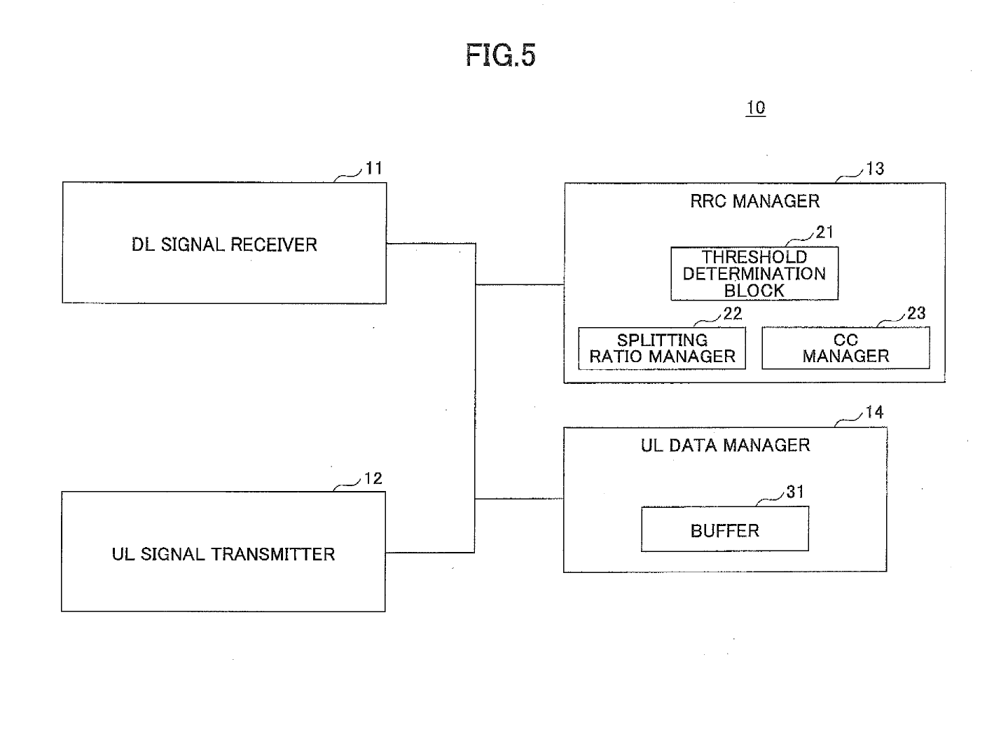

FIG. 5 is a schematic diagram of a mobile device (UE) 10 according to the embodiment. The UE has a downlink (DL) signal receiver 11, an uplink (UL) signal transmitter 12, a radio resource control (RRC) manager 13, and an uplink (UL) data manager 14.

The DL signal receiver 11 receivers a request for setting and/or changing UL bearer splitting, which request may be transmitted as an RRC signaling message. The UL data manager 14 manages the amount of UL data accumulated in a buffer 31.

The RRC manager 14 has a threshold determination block 21, a splitting ratio manager 22 and a component carrier (CC) manager 23. When a request for setting and/or changing UL bearer splitting is received at the DL signal receiver 11, the CC manager 23 checks the cell (or the component carrier) supported by a second eNB in the received request, and assigns the cell (or the component carrier) of the second eNB as a target cell of UL bearer splitting. The splitting ratio manager 22 extracts a ratio contained in the request and sets up a splitting ratio. The threshold determination block 21 manages a predetermined threshold level, and determines whether the amount of data accumulation in the buffer 31, which information is supplied from the UL data manager 14, exceeds the threshold level upon BSR triggering. The threshold comparison result is supplied to the UL data manager 14.

When the amount of data accumulation in the buffer 31 does not exceed the threshold level, the UL data manager 14 creates a BSR based upon the amount of the buffered data. The BSR is transmitted from the UL signal transmitter 12 to a specific eNB. When the amount of data accumulation in the buffer exceeds the threshold level, the UL data manger divides the amount of the buffered data according to the splitting ratio managed by the splitting ratio manager 22, and creates BSRs for the divided portions of the data accumulation. The BSRs are transmitted from the UL signal transmitter 12 to the associated eNBs.

With the above-described method and structure, component carriers are allocated efficiently according to the amount of data accumulation in the buffer 31 of UE even if UL bearer splitting is arranged under dual connectivity.

This patent application is based upon and claims the benefit of the priority of Japanese Patent Application No. 2014-015086 filed Jan. 30, 2014, which is incorporated herein by references in its entirety.

1. A mobile communication system comprising:
a first base station;
a second base station; and
a mobile device,
wherein when uplink bearer splitting is arranged between the first base station, second base station, and the mobile device at a prescribed splitting ratio, and when the amount of data accumulated in a buffer of the mobile device does not exceed a threshold level, the mobile device is configured to transmit a buffer status report to either one of the first base station or the second base station even if the uplink bearer splitting is arranged, and
wherein when the amount of data accumulated in the buffer of the mobile device exceeds the threshold level, the mobile device is configured to divide the amount of data accumulated in the buffer at the prescribed splitting ratio and transmit buffer status reports to the first base station the second base station according to the divided amounts of data accumulation.

2. The mobile communication system according to claim 1,
wherein the mobile communication system includes three or more base stations, and
wherein when uplink bearer splitting is arranged between said three or more base station and the mobile device, the mobile device is configured to determine the amount of data accumulated in the buffer using two or more threshold levels, and change a number of base stations to which buffer status reports are to be transmitted according to the determined amount of data accumulated in the buffer among said three or more base stations for which the uplink bearer splitting is arranged.

3. The mobile communication system according to claim 1,
wherein the mobile device is configured to set up a different threshold level depending on whether buffer status reporting is switched from first type reporting to transmit a buffer status report to a specific base station to second type reporting to transmit buffer status reports for divided portions of data accumulation in the buffer to multiple base station, or switched from the second type reporting to the first type reporting.

4. The mobile communication system according to claim 3,
wherein the mobile device is configured to maintain the second type reporting for a predetermined period of time after the buffer status reporting is switched to the second type reporting.

5. The mobile communication system according to claim 1,
wherein the mobile device is configured to switch buffer status reporting between first type reporting to transmit a buffer status report to a specific base station and second type reporting to transmit buffer status reports for divided portions of data accumulation in the buffer to multiple base station, based upon an amount of downlink data received for a fixed time.

6. A mobile device comprising:
a splitting ratio manager configured to manage a splitting ratio for uplink bearer splitting arranged between two or more base stations,
an uplink data manager configured to manage an amount of data accumulated in a buffer,
and
a determination unit configured to determine if the amount of data accumulated in the buffer exceeds a threshold level upon triggering a buffer status report,
wherein when the amount of data accumulated in the buffer does not exceed the threshold, the uplink data manager is configured to perform first type buffer status reporting to transmit a buffer status report to a part of the base stations even if the uplink bearer splitting is arranged, and
when the amount of data accumulated in the buffer exceeds the threshold level, the uplink data manager is configured to perform second type buffer status reporting by dividing the amount of data accumulated in the buffer at the splitting ratio and reporting buffer status reports created based upon the splitting ratio to said two or more base stations.

7. The mobile device according to claim 6,
wherein the determination unit has two or more threshold levels, and
wherein the uplink data manager is configured to change a number of base stations to which buffer status reports are to be transmitted according to the determined amount of data accumulated in the buffer among said base stations for which the uplink bearer splitting is configured.

8. The mobile device according to claim 6,
wherein the determination unit is configured to set up a different threshold level depending on whether buffer status reporting is switched from first type reporting to transmit a buffer status report to a specific base station to second type reporting to transmit buffer status reports for divided portions of data accumulation in the buffer to multiple base station, or switched from the second type reporting to the first type reporting.

9. The mobile device according to claim 8,
wherein the uplink data manager is configured to maintain the second type reporting for a predetermined period of time after the buffer status reporting is switched to the second type reporting.

10. The mobile device according to claim 6,
wherein the uplink data manager is configured to switch buffer status reporting between first type reporting to transmit a buffer status report to a specific base station and second type reporting to transmit buffer status reports for divided portions of data accumulation in the buffer to multiple base station, based upon an amount of downlink data received for a fixed time.
